(19) United States
(12) Patent Application Publication
(10) Pub. No.: US 2014/0306964 A1
(43) Pub. Date: Oct. 16, 2014

(54) INCREMENTAL COMPILING OF A DECLARATIVE PROGRAM

(71) Applicant: MICROSOFT CORPORATION, Redmond, WA (US)

(72) Inventors: Andrew Douglas Reddish, Redmond, WA (US); Olivier Colle, Bellevue, WA (US); Jaideep Sarkar, Redmond, WA (US); Nizam Anuar, Snoqualmie, WA (US); Radu B. Gruian, Sammamish, WA (US); Vijay Mital, Kirkland, WA (US); Darryl E. Rubin, Ellensburg, WA (US)

(21) Appl. No.: 13/862,257

(22) Filed: Apr. 12, 2013

(51) Int. Cl. G06T 11/20

(52) U.S. Cl. CPC G06T 11/206
USPC 345/440

(57) ABSTRACT

The incremental compiling of a recalculation user interface. As an example, the recalculation user interface may be a spreadsheet program although the principles may apply to an visualization of data sinks that are interconnected to data sources via a transformation chain. The transformation chain includes multiple declarative transformations. A dependency graph is generated through analysis of the declarative transformations of the transformation chain. As the user interacts with the recalculation user interface, the user may cause one or more changes to the transformation chain. The dependencies associated with the transformations may be identified and may be largely isolated. The compiler may then compile that one or more affected dependencies, without compiling the entire recalculation user interface.

### BACKGROUND

Traditionally, software authors generate a program using source code. The program may then be compiled and built, after which the program is run to evaluate the behavior of the program. For incremental authoring of a program, however, it is more important that the program author frequently, if no constantly, knows what they have just built, and so incremental authoring environments provide a frequent view on the behaviors of the code generated thus far. There are two conventional ways to provide such an incremental authoring environment.

One way is for the author to use the same interpreted environment that will be used after the program is deployed. This allows the compile step to be avoided in favor of an interpreter. However, this would require that the runtime shipped with the program include the same interpreted environment. Thus, the program would be shipped with a significant runtime that includes the same interpreter that was used for authoring. At runtime, the interpreter would also be used to interpret the program.

Another way is to use a rich authoring environment in which the author creates the source code, and has a separate compile and run step for each authoring increment that allows the author to see how the program behaves to that point. In some environments, this separate compile and run step may be performed automatically whenever the program author makes a change to the program. Even so, the entire program is often recompiled. The larger the program being compiled, the longer the compilation step takes, thereby degrading the incremental authoring experience.

Of course, the author can avoid recompiling the entire program if, for example, there were a limited number of modules in the program, and they interact in known ways and the author happens to be aware that the way in which the author is changing the module is not affecting the other modules. In that case, the author might not need to recompile the entire program, but would certainly recompile the module being authored. Nevertheless, there are limits to the opportunity to reduce the granularity of the program being compiled. Such limits are governed by the knowledge available to the author, and to the integral granularity of the program (e.g., the module).

### BRIEF SUMMARY

At least some embodiments described herein relate to the incremental compiling of a recalculation user interface. As an example, the recalculation user interface may be a spreadsheet program although the principles may apply to any visualization of data sinks that are interconnected to data sources via a transformation chain. The transformation chain includes multiple declarative transformations. A dependency graph is generated through analysis of the declarative transformations of the transformation chain.

As the user interacts with the recalculation user interface, the user may cause one or more changes to the transformation chain. For instance, the user might cause an addition, removal, or modification of a declarative transformation. In the case of a spreadsheet, the user might edit, add or, remove an expression from a spreadsheet cell. In an alternative recalculation user interface in which the user interacts with visualized controls, the user might cause the declarative transformation to change via manipulation of the control.

In response, the altered portion of the transformation chain is re-analyzed. Since declarative transformations tend to be edited on the granularity of transformation, and since declarative transformations may be edited while typically not impacting other transformations, the dependencies associated with the transformations may be identified. The compiler may then compile the one or more affected dependencies, without compiling the entire recalculation user interface.

This Summary is not intended to identify key features or essential features of the claimed subject matter, nor is it intended to be used as an aid in determining the scope of the claimed subject matter.

### BRIEF DESCRIPTION OF THE DRAWINGS

In order to describe the manner in which the above-recited and other advantages and features can be obtained, a more particular description of various embodiments will be rendered by reference to the appended drawings. Understanding that these drawings depict only sample embodiments and are not therefore to be considered to be limiting of the scope of the invention, the embodiments will be described and explained with additional specificity and detail through the use of the accompanying drawings in which:

FIG. 1 abstractly illustrates a computing system in which some embodiments described herein may be employed;

FIG. 2 abstractly illustrates an example recalculation user interface, which illustrates several data sources and data sinks with intervening transforms, and is used as a specific example provided to explain the broader principles described herein;

FIG. 3 illustrates an example compilation environment that includes a compiler that accesses the transformation chain and produces compiled code as well as a dependency chain; and

FIG. 4 illustrates a flowchart of a method for compiling a transformation chain of a recalculation user interface;

FIG. 5 illustrates a flowchart of a method for incrementally compiling a recalculation user interface.

FIG. 6 illustrates an environment in which the principles of the present invention may be employed including a data-driven composition framework that constructs a view composition that depends on input data;

FIG. 7 illustrates a pipeline environment that represents one example of the environment of FIG. 6;

FIG. 8 schematically illustrates an embodiment of the data portion of the pipeline of FIG. 7;

FIG. 9 schematically illustrates an embodiment of the analytics portion of the pipeline of FIG. 7; and

FIG. 10 schematically illustrates an embodiment of the view portion of the pipeline of FIG. 7.

### DETAILED DESCRIPTION

Embodiments described herein related to the incremental compiling of a recalculation user interface. As an example, the recalculation user interface may be a spreadsheet program although the principles may apply to any visualization of data sinks that are interconnected to data sources via a transformation chain. The transformation chain includes multiple declarative transformations. A dependency graph is generated through analysis of the declarative transformations of the transformation chain.

As the user interacts with the recalculation user interface, the user may cause one or more changes to the transformation chain. For instance, the user might cause an addition, removal, or modification of a declarative transformation. In the case of a spreadsheet, the user might edit, add, or remove an expression from a spreadsheet cell. In an alternative recalculation user interface in which the user interacts with visualized controls, the user might cause the declarative transformation to change via manipulation of the control.

In response, the altered portion of the transformation chain is re-analyzed. Since declarative transformations tend to be edited on the granularity of transformation, and since declarative transformations may be edited while not typically not impacting other transformations, the dependencies associated with the transformations may be identified. The compiler may then compile the one or more affected dependencies, without compiling the entire recalculation user interface.

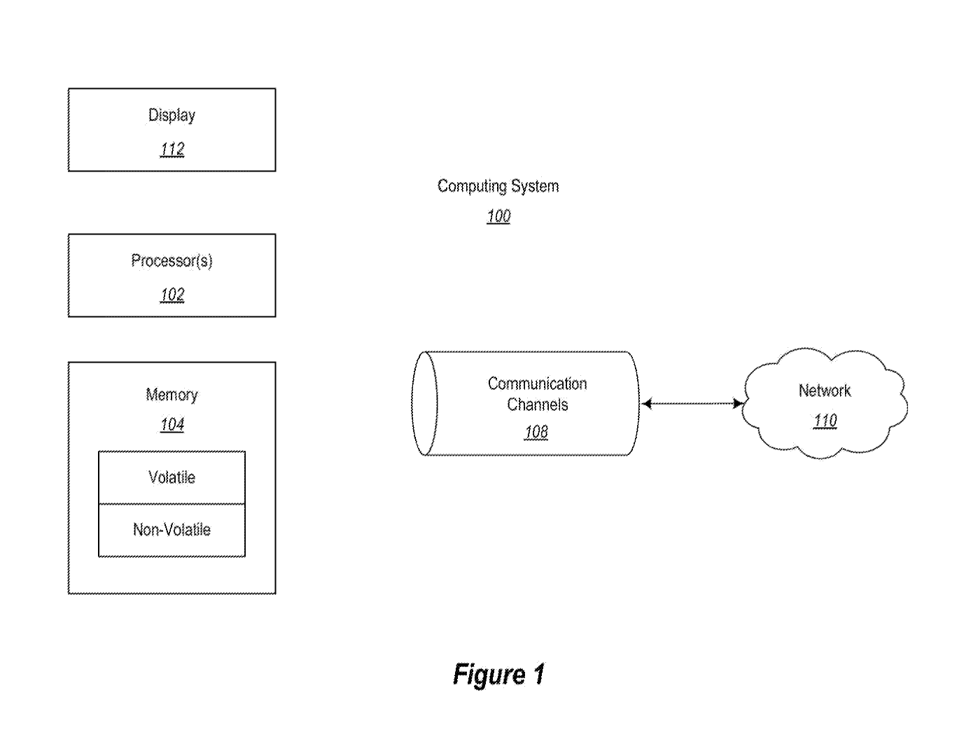

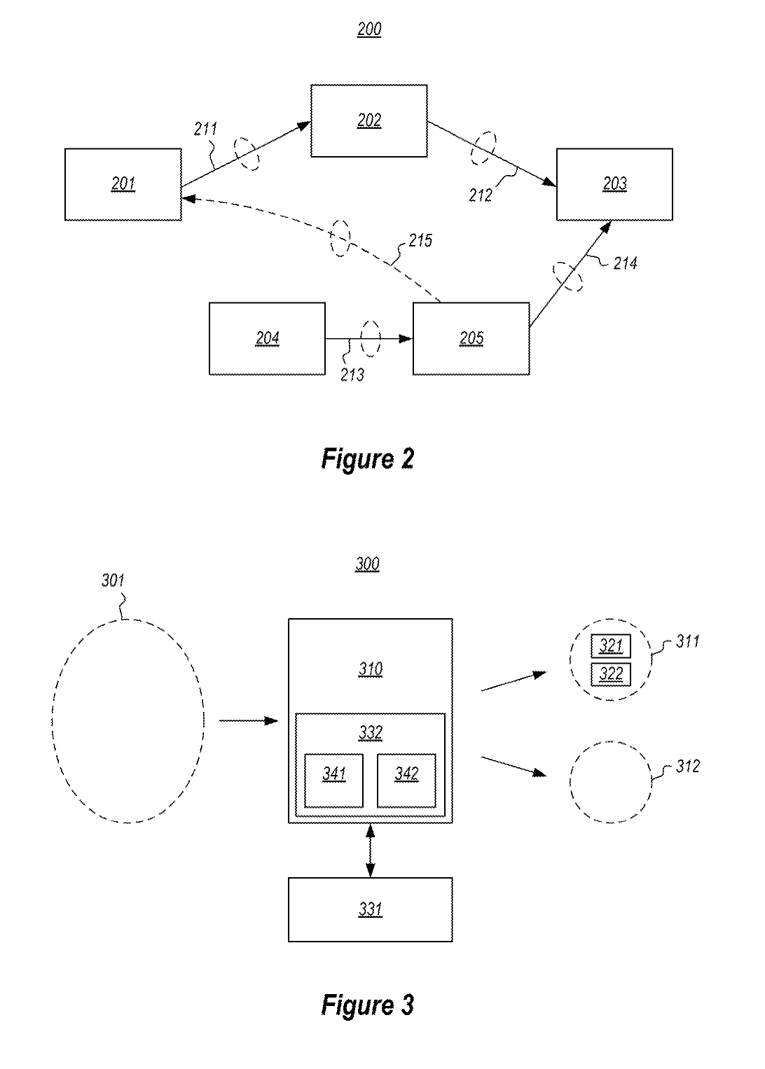

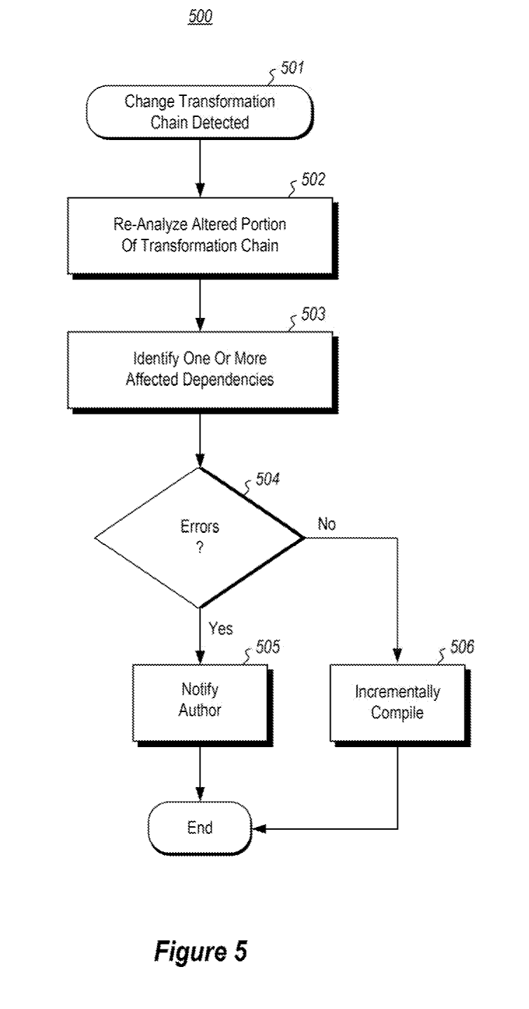

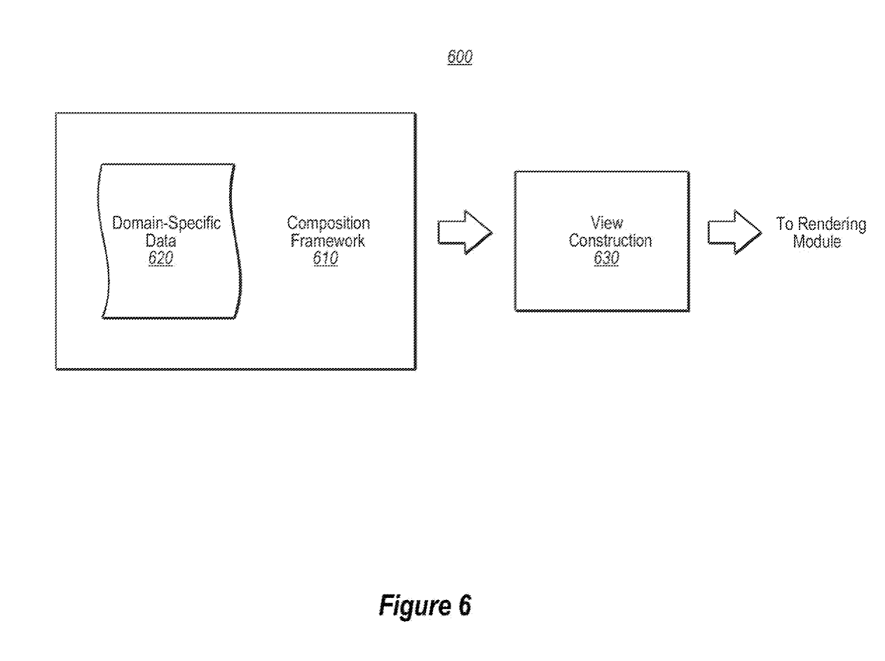

Some introductory discussion of a computing system will be described with respect to FIG. 1. Then, the compiling of the transformation chain of the recalculation user interface will be described with respect to FIGS. 2 through 4. Incremental compiling will then be described with respect to FIG. 5. Finally, an example recalculation user interface will be described with respect to FIGS. 6 through 10.

Computing systems are now increasingly taking a wide variety of forms. Computing systems may, for example, be handheld devices, appliances, laptop computers, desktop computers, mainframes, distributed computing systems, or even devices that have not conventionally been considered a computing system. In this description and in the claims, the term “computing system” is defined broadly as including any device or system (or combination thereof) that includes at least one physical and tangible processor, and a physical and tangible memory capable of having thereon computer-executable instructions that may be executed by the processor. The memory may take any form and may depend on the nature and form of the computing system. A computing system may be distributed over a network environment and may include multiple constituent computing systems.

As illustrated in FIG. 1, in its most basic configuration, a computing system 100 typically includes at least one processing unit 102 and memory 104. The memory 104 may be physical system memory, which may be volatile, non-volatile, or some combination of the two. The term “memory” may also be used herein to refer to non-volatile mass storage such as physical storage media. If the computing system is distributed, the processing, memory and/or storage capability may be distributed as well. As used herein, the term “executable module” or “executable component” can refer to software objects, routings, or methods that may be executed on the computing system. The different components, modules, engines, and services described herein may be implemented as objects or processes that execute on the computing system (e.g., as separate threads).

In the description that follows, embodiments are described with reference to acts that are performed by one or more computing systems. If such acts are implemented in software, one or more processors of the associated computing system that performs the act direct the operation of the computing system in response to having executed computer-executable instructions. For example, such computer-executable instructions may be embodied on one or more computer-readable media that form a computer program product. An example of such an operation involves the manipulation of data. The computer-executable instructions (and the manipulated data) may be stored in the memory 104 of the computing system 100. Computing system 100 may also contain communication channels 108 that allow the computing system 100 to communicate with other message processors over, for example, network 110. The computing system 100 also includes a display 112, which may be used to display visual representations to a user.

Embodiments described herein may comprise or utilize a special purpose or general-purpose computer including computer hardware, such as, for example, one or more processors and system memory, as discussed in greater detail below. Embodiments described herein also include physical and other computer-readable media for carrying or storing computer-executable instructions and/or data structures. Such computer-readable media can be any available media that can be accessed by a general purpose or special purpose computer system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: computer storage media and transmission media.

Computer storage media includes RAM, ROM, EEPROM, CD-ROM or other optical disk storage, magnetic disk storage or other magnetic storage devices, or any other tangible medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry or desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to computer storage media (or vice versa). For example, computer-executable instructions or data structures received over a network or data link can be buffered in RAM within a network interface module (e.g., a “NIC”), and then eventually transferred to computer system RAM and/or to less volatile computer storage media at a computer system. Thus, it should be understood that computer storage media can be included in computer system components that also (or even primarily) utilize transmission media.

Computer-executable instructions comprise, for example, instructions and data which, when executed at a processor, cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

In this description and in the claims, a “recalculation user interface” is an interface with which a user may interact and which occurs in an environment in which there are one or more data sources and one or more data sinks. Furthermore, there is a set of transformations that may each be declaratively defined between one or more data sources and a data sink. For instance, the output of one data source is fed into the transformation, and the result from the transformation is then provided to the data sink, resulting in potentially some kind of change in visualization to the user.

The transformations are “declarative” in the sense that a user without specific coding knowledge can write the declarations that define the transformation. As the transformation is declaratively defined, a user may change the declarative transformation. In response, a recalculation is performed, resulting in perhaps different data being provided to the data sinks.

A classic example of a recalculation user interface is a spreadsheet document. A spreadsheet document includes a grid of cells. Initially, the cells are empty, and thus any cell of the spreadsheet program has the potential to be a data source or a data sink, depending on the meaning and context of declarative expressions inputted by a user. For instance, a user might select a given cell, and type an expression into that cell. The expression might be as simple as an expressed scalar value to be assigned to that cell. That cell may later be used as a data source. Alternatively, the expression for a given cell might be in the form of an equation in which input values are taken from one or more other cells. In that case, the given cell is a data sink that displays the result of the transformation. However, during continued authoring, that cell may be used as a data sink for yet other transformations declaratively made by the author.

The author of a spreadsheet document need not be an expert on imperative code. The author is simply making declarations that define a transformation, and selecting corresponding data sinks and data sources. FIGS. 6 through 10 described hereinafter provide a more generalized declarative authoring environment in which a more generalized recalculation user interface is described. In that subsequently described environment, visualized controls may serve as both data sources and data sinks. Furthermore, the declarative transformations may be more intuitively authored by simple manipulations of those controls.

An example compilation mechanism of a recalculation user interface will now be described with reference to FIGS. 2 through 4. FIG. 2 abstractly illustrates an example recalculation user interface 200, which is a specific example provided to explain the broader principles described herein. The recalculation user interface 200 is just an example as the principles describe herein may be applied to any recalculation user interface to create a countless variety of recalculation user interfaces for a countless variety of applications.

The recalculation user interface 200 includes several declarative transformations 211 through 215. The dashed circle around each of the arrows representing the transformations 211 through 215 symbolizes that the transformations are each in declarative form.

In this specific example of FIG. 2, the transform 211 includes respective data source 201 and data sink 202. Note that a data sink for one transform may also be a data source for another transform. For instance, data sink 202 for transform 211 also serves as a data source for the transform 212. Furthermore, a transform may have multiple data sources. Thus, the transform chain can be made hierarchical, and thus quite complex. For instance, the transform 212 includes data source 202 and data sink 203. The data sink 203 includes two data sources; namely data source 202 for transform 212, and data source 205 for transform 214. That said, perhaps a single transform leads the two data sources 202 and 205 into the data sink 203. The transform 213 includes a data source 204 and a data sink 205.

If the recalculation user interface were a spreadsheet document, for example, the various data sources/sinks 201 through 205 might be spreadsheet cells, in which case the transforms represent the expression that would be associated with each data sink. The output of each expression is displayed within the cell. Thus, in the case of a spreadsheet. The data sources/sinks might be complex visualized controls that have both include input parameters to and output parameters from the transformation chain. For instance, in FIG. 2, there is an additional declarative transformation 215 that leads from data source 205 into data sink 201. Thus, the data source/sink 201 might visualize information representing an output from transform 215, as well as provide further data to other data sinks.

Recalculation user interfaces do not need to have visualization controls. One example of this is a recalculation user interface meant to perform a transformation-based computation, consuming source data and updating sink data, with no information displayed to the user about the computation in the normal case. For instance, the recalculation user interface might support a background computation. A second example is a recalculation user interface that has output controls that operate external actuators, such as the valves in the process control example. Such controls are like display controls in that their states are controlled by results of the transformation computation and on signal inputs. However, here, the output is a control signal to a device rather than a visualization to a display. Consider, for example, a recalculation user interface for controlling a robot. This recalculation user interface might have rules for robot actions and behavior that depend on inputs robot sensors like servo positions and speeds, ultrasonic range-finding measurements, and so forth. Or consider a process control application based on a recalculation user interface that takes signals from equipment sensors like valve positions, fluid flow rates, and so forth.

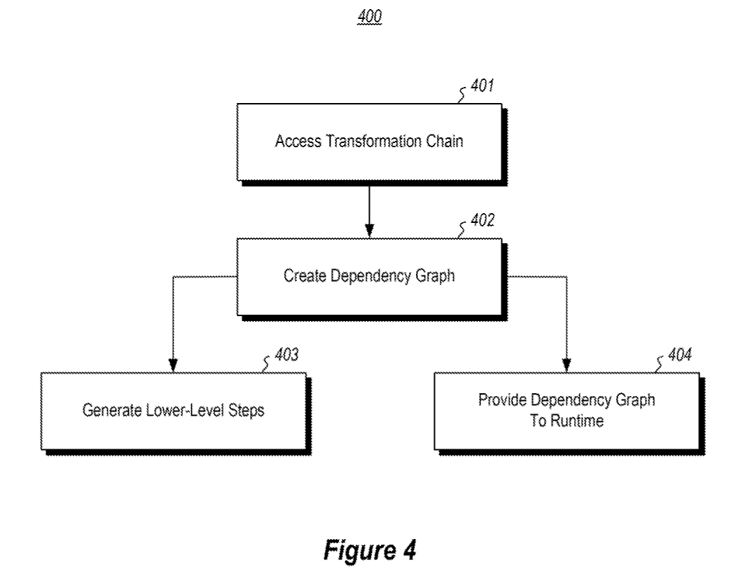

FIG. 3 illustrates an example compilation environment 300 that includes a compiler 310 that accesses the transformation chain 301. An example, of the transformation chain 301 is the transformation chain 200 of FIG. 2. FIG. 4 illustrates a flowchart of a method 400 for compiling a transformation chain of a recalculation user interface. The method 400 may be performed by the compiler 310 of FIG. 3. In one embodiment, the method 400 may be performed by the computing system 100 in response to the processor(s) 102 executing computer-executable instructions embodied on one or more computer-readable storage media.

The method 400 includes analyzing a transformation chain of the recalculation user interface for dependencies (act 401). For instance, referring to FIG. 2, the compiler 300 might analyze each of the transformations 211 through 215. The transformations are declarative and thus the dependencies can be extracted more easily than they could if the transformations were expressed using an imperative computer language.

Based on the analysis, a dependency graph is created (act 402) between entities referenced in the transformations. Essentially, the dependencies have a source entity that represents an event, and a target entity that represents that the evaluation of that target entity depends on the event. An example of the event might be a user event in which the user interacts in a certain way with the recalculation user interface. As another example, the event might be an inter-entity event in which if the source entity is evaluated, then the target entity of the dependency should also be evaluated.

The compiler then creates lower-level execution steps based on the dependency graph (act 403). The lower-level execution steps might be, for instance, imperative language code. Imperative language code is adapted to respond to detect events, reference an event chart to determine a function to execute, and execute that function. Accordingly, each of the dependencies in the dependency graph may be reduced to a function. The dependency graph itself may be provided to the runtime (act 404). The imperative language code may be, for example, a script language, such as JAVASCRIPT. However, the principles described herein are not limited to the imperative language code being of any particular language.

As an example, FIG. 3 illustrates that the compiler 310 generates lower-level code 311 as well. Such lower level code 311 includes a compilation of each of the transformations in the transformation chain. For instance, lower level code 311 is illustrated as including element 321 representing the compilation of each of the transformations in the transformation chain. In the context of FIG. 2, the element 321 would include a compilation of each of the transformations 211 through 215. The lower level code 311 also includes a variety of functions 322. A function is generated for each dependency in the dependency graph. The functions may be imperative language functions.

When the imperative language runtime detects an event that is listed in the dependency graph, the corresponding function within the compiled functions 322 is also executed. Accordingly, with all transformations being properly compiled, and with each of the dependencies on particular events being enforced by dedicated functions, the declarative recalculation user interface is properly represented as an imperative language code.

Accordingly, an effective mechanism has been described for compiling a declarative recalculation user interface. In addition, the runtime is provided with a dependency graph, rather than a more extensive interpreter.

The environment described with respect to FIGS. 2 through 4 not only allows for the compiling of a recalculation user interface, but also allows for incremental changes to the recalculation user interface to be incrementally compiled. This facilitates an incremental authoring experience in which the user may more quickly verify the behavior of the recalculation user interface without requiring an interpreter be deployed with the final product, and without requiring a complete recompile of the recalculation user interface between incremental changes.

As the user interacts with the recalculation user interface, the user may cause one or more changes to the transformation chain. For instance, the user might cause an addition, removal, or modification of a declarative transformation. In the case of a spreadsheet, the user might edit, add, or remove an expression from a spreadsheet cell. In an alternative recalculation user interface in which the user interacts with visualized controls, the user might cause the declarative transformation to change via manipulation of the control.

In response, the altered portion of the transformation chain is re-analyzed. Since declarative transformations tend to be edited on the granularity of transformation, and since declarative transformations may be edited while not typically not impacting other transformations, the dependencies associated with the transformations may be identified. The compiler may then compile that one or more affected dependencies, without compiling the entire recalculation user interface.

Referring to FIG. 3, the compilation environment 300 also includes an authoring component 331 for assisting a user in authoring the recalculation user interface that includes the transformation chain 200 or 301. The compilation environment 300 also includes an analysis module 332 configured to generate a dependency graph 312 through analysis of the transformation chain 301. The analysis module 332 includes a change detection mechanism 341 that detects when a change is made to the transformation chain 301 via the authoring component 331 in the form of an added, removed, or modified declarative transformation. In response to a change, the analysis module 332 is configured to re-analyze the altered portion of the transformation chain 301 and to identify one or more affected dependencies of the dependency graph.

The compiler 310 then may respond to the change by incrementally compiling a portion of the recalculation user interface that includes the one or more affected dependencies, without compiling the entire recalculation user interface. The compiler may compile a portion of the recalculated interface at a granularity of a function of an imperative language. For instance, as described above, there may be an imperative language function for each dependency in the dependency graph. Only those one or more functions related to the one or more affected dependencies need be recompiled.

The analysis module 332 further includes an error detection module 342 that detects when there are errors in the dependency graph. The compiler 310 may be restricted from incrementally compiling when there are no errors detected in the dependency graph. Furthermore, the user may be prompted to correct errors when there are errors detected in the dependency graph, making it more likely that subsequent changes from the authoring component 331 will result in correction of the errors, thereby allowing incremental compiling.

FIG. 5 illustrates a flowchart of a method 500 for incrementally compiling a recalculation user interface. The method 500 may be performed in the context of there being a preexisting dependency graph generated up to some point in the authoring process. The method 500 is initiated upon detecting that a change is made to the transformation chain (initiating event 501) via an addition, removal, or modification of a declarative transformation. For instance, the change detection mechanism 331 may detect this change in the transformation chain 301 caused by authoring activity occurring in the authoring component 301.

The method 500 then re-analyzes the altered portion of the transformation chain (act 502). For instance, there may be as few as one transformation edited by the author. In that case, just that single declarative transformation might be analyzed. The re-analysis identifies one or more affected dependencies of the dependency graph (act 503). This might be accomplished by, for example, the analysis module 332 of FIG. 3. If there are errors in the dependency graph (“Yes” in decision block 504), then the user is notified of the errors (act 505), and the method 500 ends to await further authored changes to the recalculation user interface. If there are no errors in the dependency graph (“No” in decision block 504), the incremental compilation occurs (act 506), and the method ends until the next time authored changes of the transformation chain are detected (initiating event 501).

The time required to incrementally compile is negligible compared to the time required to compile an entire program. Accordingly, the authoring experience is not impeded by lengthy compilation processes. Instead, the author makes a change, and can quickly verify that the resulting behavior is as intended (or see errors that need to be corrected before the behavior can be evaluated. Thus, an effective incremental authoring experience is provided even without the need for deploying a substantial interpreter with the final product.

A specific example of an authoring pipeline for allowing non-programmers to author programs having complex behaviors using a recalculation user interface will now be described with respect to FIGS. 6 through 10.

FIG. 6 illustrates a visual composition environment 600 that may be used to construct an interactive visual composition in the form of a recalculation user interface. The construction of the recalculation user interface is performed using data-driven analytics and visualization of the analytical results. The environment 600 includes a composition framework 610 that performs logic that is performed independent of the problem-domain of the view composition 630. For instance, the same composition framework 610 may be used to compose interactive view compositions for city plans, molecular models, grocery shelf layouts, machine performance or assembly analysis, or other domain-specific renderings.

The composition framework 610 uses domain-specific data 620, however, to construct the actual visual composition 630 that is specific to the domain. Accordingly, the same composition framework 610 may be used to recalculation user interfaces for any number of different domains by changing the domain-specific data 620, rather than having to recode the composition framework 610 itself. Thus, the composition framework 610 of the pipeline 600 may apply to a potentially unlimited number of problem domains, or at least to a wide variety of problem domains, by altering data, rather than recoding and recompiling. The view composition 630 may then be supplied as instructions to an appropriate 2-D or 3-D rendering module. The architecture described herein also allows for convenient incorporation of pre-existing view composition models as building blocks to new view composition models. In one embodiment, multiple view compositions may be included in an integrated view composition to allow for easy comparison between two possible solutions to a model.

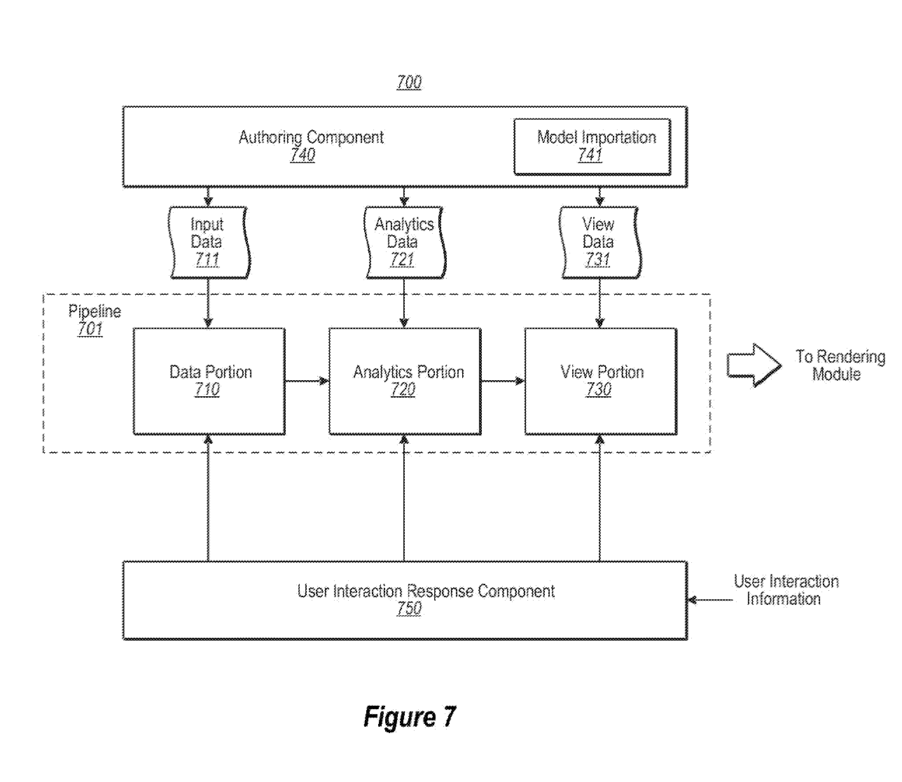

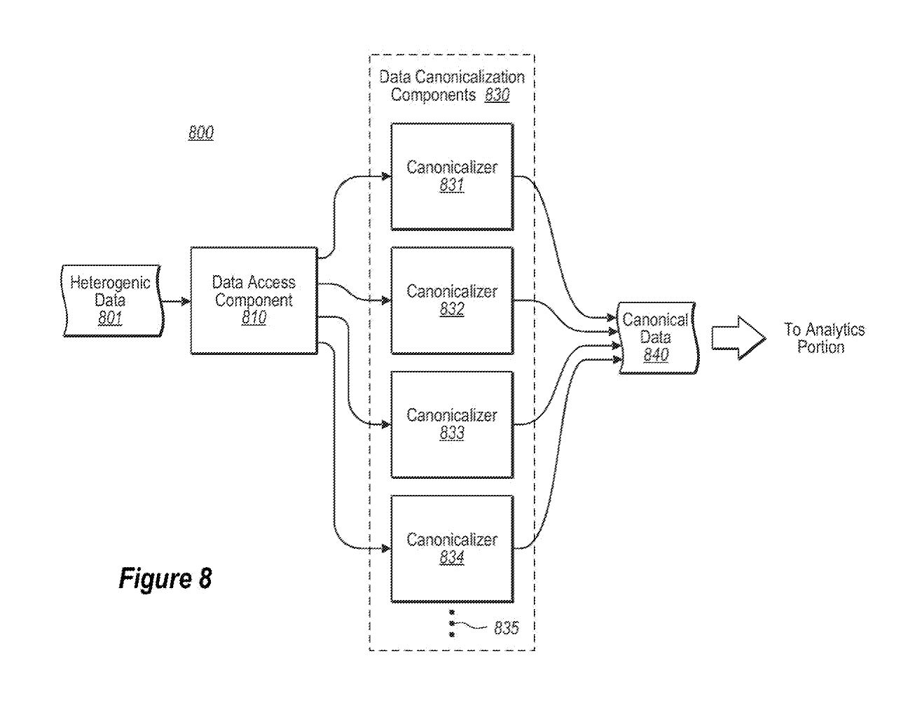

FIG. 7 illustrates an example architecture of the composition framework 610 in the form of a pipeline environment 700. The pipeline environment 700 includes, amongst other things, the pipeline 701 itself. The pipeline 701 includes a data portion 710, an analytics portion 720, and a view portion 730, which will each be described in detail with respect to subsequent FIGS. 8 through 10, respectively, and the accompanying description. For now, at a general level, the data portion 710 of the pipeline 701 may accept a variety of different types of data and presents that data in a canonical form to the analytics portion 720 of the pipeline 701. The analytics portion 720 binds the data to various model parameters, and solves for the unknowns in the model parameters using model analytics. The various parameter values are then provided to the view portion 730, which constructs the composite view using those values if the model parameters.

The pipeline environment 700 also includes an authoring component 740 that allows an author or other user of the pipeline 701 to formulate and/or select data to provide to the pipeline 701. For instance, the authoring component 740 may be used to supply data to each of data portion 710 (represented by input data 711), analytics portion 720 (represented by analytics data 721), and view portion 730 (represented by view data 731). The various data 711, 721 and 731 represent an example of the domain-specific data 620 of FIG. 6, and will be described in much further detail hereinafter. The authoring component 740 supports the providing of a wide variety of data including for example, data schemas, actual data to be used by the model, the location or range of possible locations of data that is to be brought in from external sources, visual (graphical or animation) objects, user interface interactions that can be performed on a visual, modeling statements (e.g., views, equations, constraints), bindings, and so forth. In one embodiment, the authoring component is but one portion of the functionality provided by an overall manager component (not shown in FIG. 7, but represented by the composition framework 610 of FIG. 6). The manager is an overall director that controls and sequences the operation of all the other components (such as data connectors, solvers, viewers, and so forth) in response to events (such as user interaction events, external data events, and events from any of the other components such as the solvers, the operating system, and so forth).

In the pipeline environment 700 of FIG. 7, the authoring component 740 is used to provide data to an existing pipeline 701, where it is the data that drives the entire process from defining the input data, to defining the analytical model (referred to above as the “transformation chain”), to defining how the results of the transformation chain are visualized in the view composition. Accordingly, one need not perform any coding in order to adapt the pipeline 701 to any one of a wide variety of domains and problems. Only the data provided to the pipeline 701 is what is to change in order to apply the pipeline 701 to visualize a different view composition either from a different problem domain altogether, or to perhaps adjust the problem solving for an existing domain. Further, since the data can be changed at use time (i.e., run time), as well as at author time, the model can be modified and/or extended at runtime. Thus, there is less, if any, distinction between authoring a model and running the model. Because all authoring involves editing data items and because the software runs all of its behavior from data, every change to data immediately affects behavior without the need for recoding and recompilation.

The pipeline environment 700 also includes a user interaction response module 750 that detects when a user has interacted with the displayed view composition, and then determines what to do in response. For example, some types of interactions might require no change in the data provided to the pipeline 701 and thus require no change to the view composition. Other types of interactions may change one or more of the data 711, 721, or 731. In that case, this new or modified data may cause new input data to be provided to the data portion 710, might require a reanalysis of the input data by the analytics portion 720, and/or might require a re-visualization of the view composition by the view portion 730.

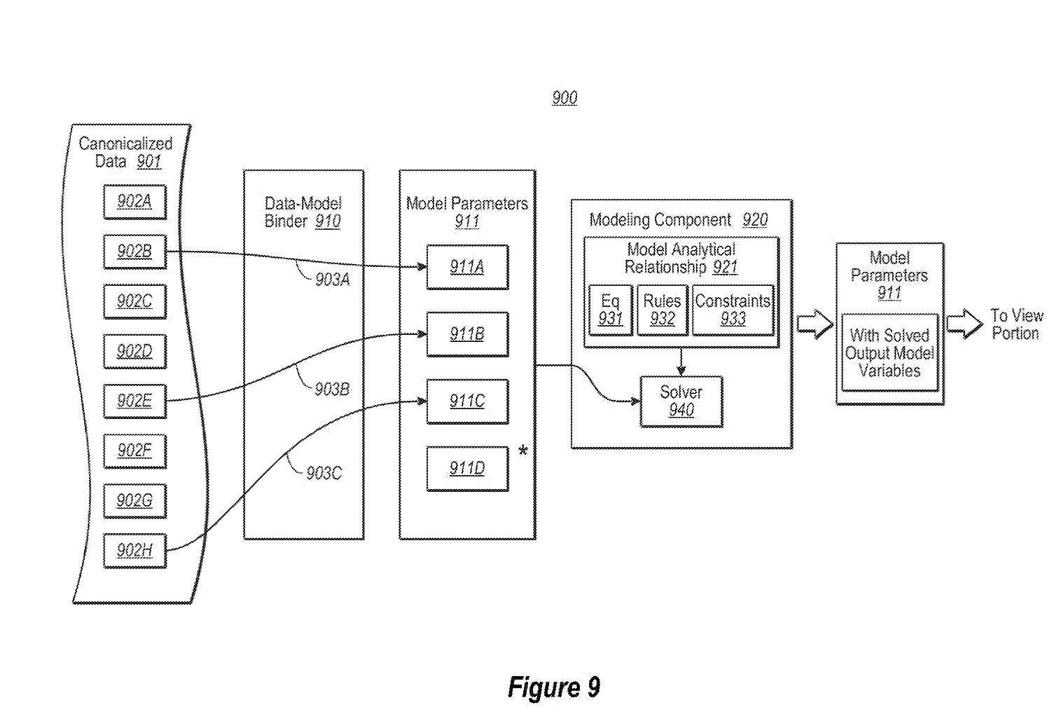

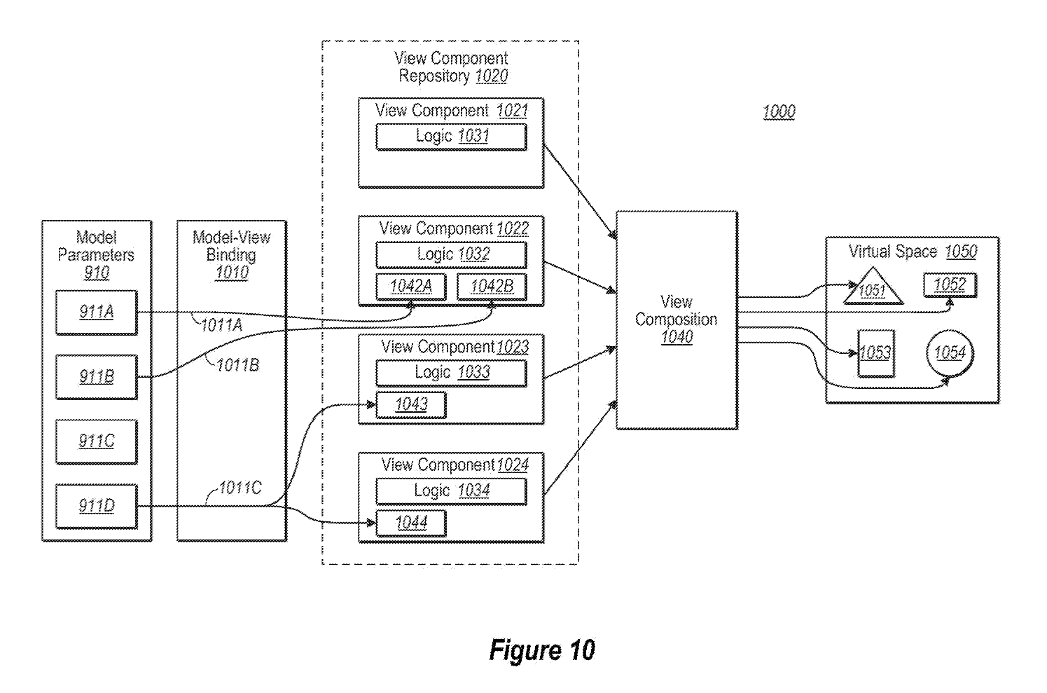

Accordingly, the pipeline 701 may be used to extend data-driven analytical visualizations to perhaps an unlimited number of problem domains, or at least to a wide variety of problem domains. Furthermore, one need not be a programmer to alter the view composition to address a wide variety of problems. Each of the data portion 710, the analytics portion 720 and the view portion 730 of the pipeline 701 will now be described with respect to respective data portion 800 of FIG. 8, the analytics portion 900 of FIG. 9, and the view portion 1000 of FIG. 10, in that order. As will be apparent from FIGS. 8 through 10, the pipeline 701 may be constructed as a series of transformation component where they each 1) receive some appropriate input data, 2) perform some action in response to that input data (such as performing a transformation on the input data), and 3) output data which then serves as input data to the next transformation component.

FIG. 8 illustrates just one of many possible embodiments of a data portion 800 of the pipeline 701 of FIG. 7. One of the functions of the data portion 800 is to provide data in a canonical format that is consistent with schemas understood by the analytics portion 900 of the pipeline discussed with respect to FIG. 9. The data portion includes a data access component 810 that accesses the heterogenic data 801. The input data 801 may be “heterogenic” in the sense that the data may (but need not) be presented to the data access component 810 in a canonical form. In fact, the data portion 800 is structured such that the heterogenic data could be of a wide variety of formats. Examples of different kinds of domain data that can be accessed and operated on by models include text and XML documents, tables, lists, hierarchies (trees), SQL database query results, BI (business intelligence) cube query results, graphical information such as 2D drawings and 3D visual models in various formats, and combinations thereof (i.e., a composite). Further, the kind of data that can be accessed can be extended declaratively, by providing a definition (e.g., a schema) for the data to be accessed. Accordingly, the data portion 800 permits a wide variety of heterogenic input into the model, and also supports runtime, declarative extension of accessible data types.

In one embodiment, the data access portion 800 includes a number of connectors for obtaining data from a number of different data sources. Since one of the primary functions of the connector is to place corresponding data into canonical form, such connectors will often be referred to hereinafter and in the drawings as “canonicalizers”. Each canonicalizer might have an understanding of the specific Application Program Interfaces (API's) of its corresponding data source. The canonicalizer might also include the corresponding logic for interfacing with that corresponding API to read and/or write data from and to the data source. Thus, canonicalizers bridge between external data sources and the memory image of the data.

The data access component 810 evaluates the input data 801. If the input data is already canonical and thus processable by the analytics portion 900, then the input data may be directly provided as canonical data 840 to be input to the analytics portion 900.

However, if the input data 801 is not canonical, then the appropriate data canonicalization component 830 is able to convert the input data 801 into the canonical format. The data canonicalization components 830 are actually a collection of data canonicalization components 830, each capable of converting input data having particular characteristics into canonical form. The collection of canonicalization components 830 is illustrated as including four canonicalization components 831, 832, 833 and 834. However, the ellipses 835 represents that there may be other numbers of canonicalization components as well, perhaps even fewer that the four illustrated.

The input data 801 may even include a canonicalizer itself as well as an identification of correlated data characteristic(s). The data portion 800 may then register the correlated data characteristics, and provide the canonicalization component to the data canonicalization component collection 830, where it may be added to the available canonicalization components. If input data is later received that has those correlated characteristics, the data portion 810 may then assign the input data to the correlated canonicalization component. Canonicalization components can also be found dynamically from external sources, such as from defined component libraries on the web. For example, if the schema for a given data source is known but the needed canonicalizer is not present, the canonicalizer can be located from an external component library, provided such a library can be found and contains the needed components. The pipeline might also parse data for which no schema is yet known and compare parse results versus schema information in known component libraries to attempt a dynamic determination of the type of the data, and thus to locate the needed canonicalizer components.

Alternatively, instead of the input data including all of the canonicalization component, the input data may instead provide a transformation definition defining canonicalization transformations. The collection 830 may then be configured to convert that transformations definition into a corresponding canonicalization component that enforces the transformations along with zero or more standard default canonicalization transformation. This represents an example of a case in which the data portion 800 consumes the input data and does not provide corresponding canonicalized data further down the pipeline. In perhaps most cases, however, the input data 801 results in corresponding canonicalized data 840 being generated.

In one embodiment, the data portion 810 may be configured to assign input data to the data canonicalization component on the basis of a file type and/or format type of the input data. Other characteristics might include, for example, a source of the input data. A default canonicalization component may be assigned to input data that does not have a designated corresponding canonicalization component. The default canonicalization component may apply a set of rules to attempt to canonicalize the input data. If the default canonicalization component is not able to canonicalize the data, the default canonicalization component might trigger the authoring component 640 of FIG. 6 to prompt the user to provide a schema definition for the input data. If a schema definition does not already exist, the authoring component 640 might present a schema definition assistant to help the author generate a corresponding schema definition that may be used to transform the input data into canonical form. Once the data is in canonical form, the schema that accompanies the data provides sufficient description of the data that the rest of the pipeline 701 does not need new code to interpret the data. Instead, the pipeline 701 includes code that is able to interpret data in light of any schema that is expressible an accessible schema declaration language.

Regardless, canonical data 840 is provided as output data from the data portion 800 and as input data to the analytics portion 900. The canonical data might include fields that include a variety of data types. For instance, the fields might includes simple data types such as integers, floating point numbers, strings, vectors, arrays, collections, hierarchical structures, text, XML documents, tables, lists, SQL database query results, BI (business intelligence) cube query results, graphical information such as 2D drawings and 3D visual models in various formats, or even complex combinations of these various data types. As another advantage, the canonicalization process is able to canonicalize a wide variety of input data. Furthermore, the variety of input data that the data portion 800 is able to accept is expandable. This is helpful in the case where multiple models are combined as will be discussed later in this description.

FIG. 9 illustrates analytics portion 900 which represents an example of the analytics portion 720 of the pipeline 701 of FIG. 7. The data portion 800 provided the canonicalized data 901 to the data-model binding component 910. While the canonicalized data 901 might have any canonicalized form, and any number of parameters, where the form and number of parameters might even differ from one piece of input data to another. For purposes of discussion, however, the canonical data 901 has fields 902A through 902H, which may collectively be referred to herein as “fields 902”.

On the other hand, the analytics portion 900 includes a number of model parameters 911. The type and number of model parameters may differ according to the model. However, for purposes of discussion of a particular example, the model parameters 911 will be discussed as including model parameters 911A, 911B, 911C and 911D. In one embodiment, the identity of the model parameters, and the analytical relationships between the model parameters may be declaratively defined without using imperative coding.

A data-model binding component 910 intercedes between the canonicalized data fields 902 and the model parameters 911 to thereby provide bindings between the fields. In this case, the data field 902B is bound to model parameter 911A as represented by arrow 903A. In other words, the value from data field 902B is used to populate the model parameter 911A. Also, in this example, the data field 902E is bound to model parameter 911B (as represented by arrow 903B), and data field 902H is bound to model parameter 911C (as represented by arrow 903C).

The data fields 902A, 902C, 902D, 902F and 902G are not shown bound to any of the model parameters. This is to emphasize that not all of the data fields from input data are always required to be used as model parameters. In one embodiment, one or more of these data fields may be used to provide instructions to the data-model binding component 910 on which fields from the canonicalized data (for this canonicalized data or perhaps any future similar canonicalized data) are to be bound to which model parameter. This represents an example of the kind of analytics data 721 that may be provided to the analytics portion 720 of FIG. 7. The definition of which data fields from the canonicalized data are bound to which model parameters may be formulated in a number of ways. For instance, the bindings may be 1) explicitly set by the author at authoring time, 2) explicit set by the user at use time (subject to any restrictions imposed by the author), 3) automatic binding by the authoring component 740 based on algorithmic heuristics, and/or 4) prompting by the authoring component of the author and/or user to specify a binding when it is determined that a binding cannot be made algorithmically. Thus bindings may also be resolved as part of the model logic itself.

The ability of an author to define which data fields are mapped to which model parameters gives the author great flexibility in being able to use symbols that the author is comfortable with to define model parameters. For instance, if one of the model parameters represents pressure, the author can name that model parameter “Pressure” or “P” or any other symbol that makes sense to the author. The author can even rename the model parameter which, in one embodiment, might cause the data model binding component 910 to automatically update to allow bindings that were previously to the model parameter of the old name to instead be bound to the model parameter of the new name, thereby preserving the desired bindings. This mechanism for binding also allows binding to be changed declaratively at runtime.

The model parameter 911D is illustrated with an asterisk to emphasize that in this example, the model parameter 911D was not assigned a value by the data-model binding component 910. Accordingly, the model parameter 911D remains an unknown. In other words, the model parameter 911D is not assigned a value.

The modeling component 920 performs a number of functions. First, the modeling component 920 defines analytical relationships 921 between the model parameters 911. The analytical relationships 921 are categorized into three general categories including equations 931, rules 932 and constraints 933. However, the list of solvers is extensible. In one embodiment, for example, one or more simulations may be incorporated as part of the analytical relationships provided a corresponding simulation engine is provided and registered as a solver.

The term “equation” as used herein aligns with the term as it is used in the field of mathematics.

The term “rules” as used herein means a conditional statement where if one or more conditions are satisfied (the conditional or “if” portion of the conditional statement), then one or more actions are to be taken (the consequence or “then” portion of the conditional statement). A rule is applied to the model parameters if one or more model parameters are expressed in the conditional statement, or one or more model parameters are expressed in the consequence statement.

The term “constraint” as used herein means that a restriction is applied to one or more model parameters. For instance, in a city planning model, a particular house element may be restricted to placement on a map location that has a subset of the total possible zoning designations. A bridge element may be restricted to below a certain maximum length, or a certain number of lanes.

An author that is familiar with the model may provide expressions of these equations, rules and constraint that apply to that model. In the case of simulations, the author might provide an appropriate simulation engine that provides the appropriate simulation relationships between model parameters. The modeling component 920 may provide a mechanism for the author to provide a natural symbolic expression for equations, rules and constraints. For example, an author of a thermodynamics related model may simply copy and paste equations from a thermodynamics textbook. The ability to bind model parameters to data fields allows the author to use whatever symbols the author is familiar with (such as the exact symbols used in the author's relied-upon textbooks) or the exact symbols that the author would like to use.

Prior to solving, the modeling component 920 also identifies which of the model parameters are to be solved for (i.e., hereinafter, the “output model variable” if singular, or “output model variables” if plural, or “output model variable(s)” if there could be a single or plural output model variables). The output model variables may be unknown parameters, or they might be known model parameters, where the value of the known model parameter is subject to change in the solve operation. In the example of FIG. 9, after the data-model binding operation, model parameters 911A, 911B and 911C are known, and model parameter 911D is unknown. Accordingly, unknown model parameter 911D might be one of the output model variables. Alternatively or in addition, one or more of the known model parameters 911A, 911B and 911C might also be output model variables. The solver 940 then solves for the output model variable(s), if possible. In one embodiment described hereinafter, the solver 940 is able to solve for a variety of output model variables, even within a single model so long as sufficient input model variables are provided to allow the solve operation to be performed. Input model variables might be, for example, known model parameters whose values are not subject to change during the solve operation. For instance, in FIG. 9, if the model parameters 911A and 911D were input model variables, the solver might instead solve for output model variables 911B and 911C instead. In one embodiment, the solver might output any one of a number of different data types for a single model parameter. For instance, some equation operations (such as addition, subtraction, and the like) apply regardless of the whether the operands are integers, floating point, vectors of the same, or matrices of the same.

In one embodiment, even when the solver 940 cannot solve for a particular output model variables, the solver 900 might still present a partial solution for that output model variable, even if a full solve to the actual numerical result (or whatever the solved-for data type) is not possible. This allows the pipeline to facilitate incremental development by prompting the author as to what information is needed to arrive at a full solve. This also helps to eliminate the distinction between author time and use time, since at least a partial solve is available throughout the various authoring stages. For an abstract example, suppose that the analytics model includes an equation a=b+c+d. Now suppose that a, c and d are output model variables, and b is an input model variable having a known value of 5 (an integer in this case). In the solving process, the solver 940 is only able to solve for one of the output model variables “d”, and assign a value of 7 (an integer) to the model parameter called “d”, but the solver 940 is not able to solve for “c”. Since “a” depends from “c”, the model parameter called “a” also remains an unknown and unsolved for. In this case, instead of assigning an integer value to “a”, the solver might do a partial solve and output the string value of “c+11” to the model parameter “a”. As previously mentioned, this might be especially helpful when a domain expert is authoring an analytics model, and will essential serve to provide partial information regarding the content of model parameter “a” and will also serve to cue the author that some further model analytics needs to be provided that allow for the “c” model parameter to be solved for. This partial solve result may be perhaps output in some fashion in the view composition to allow the domain expert to see the partial result.

The solver 940 is shown in simplified form in FIG. 9. However, the solver 940 may direct the operation of multiple constituent solvers as will be described with respect to FIG. 10. In FIG. 9, the modeling component 920 then makes the model parameters (including the now known and solved-for output model variables) available as output to be provided to the view portion 1000 of FIG. 10.

FIG. 10 illustrates a view portion 1000 which represents an example of the view portion 730 of FIG. 7, and represents example of visualized controls in the recalculation user interface 200. The view portion 1000 receives the model parameters 911 from the analytics portion 900 of FIG. 9. The view portion also includes a view components repository 1020 that contains a collection of view components. For example, the view components repository 1020 in this example is illustrated as including view components 1021 through 1024, although the view components repository 1020 may contain any number of view components. The view components each may include zero or more input parameters. For example, view component 1021 does not include any input parameters. However, view component 1022 includes two input parameters 1042A and 1042B. View component 1023 includes one input parameter 1043, and view component 1024 includes one input parameter 1044. That said, this is just an example. The input parameters may, but need not necessary, affect how the visual item is rendered. The fact that the view component 1021 does not include any input parameters emphasizes that there can be views that are generated without reference to any model parameters. Consider a view that comprises just fixed (built-in) data that does not change. Such a view might for example constitute reference information for the user. Alternatively, consider a view that just provides a way to browse a catalog, so that items can be selected from it for import into a model.

Each view component 1021 through 1024 includes or is associated with corresponding logic that, when executed by the view composition component 1040 using the corresponding view component input parameter(s), if any, causes a corresponding view item to be placed in virtual space 1050. That virtual item may be a static image or object, or may be a dynamic animated virtual item or object For instance, each of view components 1021 through 1024 are associated with corresponding logic 1031 through 1034 that, when executed causes the corresponding virtual item 1051 through 1054, respectively, to be rendered in virtual space 1050. The virtual items are illustrated as simple shapes. However, the virtual items may be quite complex in form perhaps even including animation. In this description, when a view item is rendered in virtual space, that means that the view composition component has authored sufficient instructions that, when provided to the rendering engine, the rendering engine is capable if displaying the view item on the display in the designated location and in the designated manner.

The view components 1021 through 1024 may be provided perhaps even as view data to the view portion 1000 using, for example, the authoring component 740 of FIG. 7. For instance, the authoring component 740 might provide a selector that enables the author to select from several geometric forms, or perhaps to compose other geometric forms. The author might also specify the types of input parameters for each view component, whereas some of the input parameters may be default input parameters imposed by the view portion 1000. The logic that is associated with each view component 1021 through 1024 may be provided also a view data, and/or may also include some default functionality provided by the view portion 1000 itself.

The view portion 1000 includes a model-view binding component 1010 that is configured to bind at least some of the model parameters to corresponding input parameters of the view components 1021 through 1024. For instance, model parameter 911A is bound to the input parameter 1042A of view component 1022 as represented by arrow 1011A. Model parameter 911B is bound to the input parameter 1042B of view component 1022 as represented by arrow 1011B. Also, model parameter 911D is bound to the input parameters 1043 and 1044 of view components 1023 and 1024, respectively, as represented by arrow 1011C. The model parameter 911C is not shown bound to any corresponding view component parameter, emphasizing that not all model parameters need be used by the view portion of the pipeline, even if those model parameters were essential in the analytics portion. Also, the model parameter 911D is shown bound to two different input parameters of view components representing that the model parameters may be bound to multiple view component parameters. In one embodiment, the definition of the bindings between the model parameters and the view component parameters may be formulated by 1) being explicitly set by the author at authoring time, 2) explicit set by the user at use time (subject to any restrictions imposed by the author), 3) automatic binding by the authoring component 740 based on algorithmic heuristics, and/or 4) prompting by the authoring component of the author and/or user to specify a binding when it is determined that a binding cannot be made algorithmically.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A system comprising:
an authoring component for authoring a recalculation user interface including a transformation chain that includes a plurality of declarative transformations;
an analysis module configured to generate a dependency graph through analysis of the transformation chain, the analysis module further including a change detection mechanism configured to detect when a change is made to the transformation chain via the authoring component in the form of an added, removed, or modified declarative transformation, wherein the analysis module is configured to re-analyze the altered portion of the transformation chain to identify one or more affected dependencies of the dependency graph; and
a compiler configured to incrementally compile a portion of the recalculation interface that includes the one or more affected dependencies, without compiling the entire recalculation user interface.

2. The system in accordance with claim 1, wherein the recalculation user interface is a spreadsheet document.

3. The system in accordance with claim 1, wherein the recalculation user interface has a complex control that has input parameters to and output parameters from the transformation chain.

4. The system in accordance with claim 1, wherein the transformation chain includes at least one of a transformation from a data source to a control, or a transformation from a data source to a data sink, or a transformation from a control to a control.

5. The system in accordance with claim 1, wherein the transformation chain includes transformations from a control to another control.

6. The system in accordance with claim 1, wherein the dependency graph includes an inter-entity dependency identification from which it can be determined that if a first entity is evaluated, then a second entity is also to be evaluated.

7. The system in accordance with claim 1, wherein the dependency graph includes a user event dependency from which it can be determined that if a user event occurs, then an entity is to evaluated.

8. The system in accordance with claim 1, wherein the compiler is configured to compile a portion of the recalculation user interface at a granularity of a function of an imperative language.

9. The system in accordance with claim 1, wherein the dependency graph includes a function for each dependency.

10. The system in accordance with claim 1, wherein the analysis module further includes an error detection module that detects when there are errors in the dependency graph, wherein the compiler is restricted from incrementally compiling when there are no errors detected in the dependency graph.

11. The system in accordance with claim 10, wherein the error detection module further causes the authoring module to prompt a user to correct one or more detected errors.

12. A method for incrementally compiling a recalculation user interface comprising:
an act of generating a dependency graph through analysis of a transformation chain of a recalculation user interface, the transformation chain including a plurality of declarative transformations;
an act of detecting when a change is made to the transformation chain via an addition, removal, or modification of a declarative transformation;
in response to the act of detecting, an act of re-analyzing the altered portion of the transformation chain to identify one or more affected dependencies of the dependency graph; and
an act of incrementally compiling a portion of the recalculation interface that includes the one or more affected dependencies, without compiling the entire recalculation user interface.

13. The method in accordance with claim 12, wherein the recalculation user interface is a spreadsheet document.

14. The method in accordance with claim 12, wherein the recalculation user interface has a complex control that has input parameters to and output parameters from the transformation chain.

15. The method in accordance with claim 12, wherein the transformation chain includes at least one of a transformation from a data source to a control, or a transformation from a control to a control, or a transformation from a data source to a data sink.

16. The method in accordance with claim 12, wherein the compiler is configured to compile a portion of the recalculation user interface at a granularity of a function of an imperative language.

17. The method in accordance with claim 12, wherein the dependency graph includes a function for each dependency.

18. The method in accordance with claim 12, further comprising:
an act of detecting when there are errors in the dependency graph, wherein the an act of incrementally compiling is restricted from incrementally compiling when there are no errors detected in the dependency graph.

19. The method in accordance with claim 18, further comprising an act of prompt a user to correct one or more detected errors.

20. A computer program product comprising one or more computer-readable storage media having thereon computer-executable instructions that are structured such that, when executed by one or more processors of a computing system, cause the computing system to perform a method for incrementally compiling a recalculation user interface comprising:
an act of generating a dependency graph through analysis of a transformation chain of a recalculation user interface, the transformation chain including a plurality of declarative transformations;
an act of detecting when a change is made to the transformation chain via an addition, removal, or modification of a declarative transformation;
in response to the act of detecting, an act of re-analyzing the altered portion of the transformation chain to identify one or more affected dependencies of the dependency graph; and
an act of incrementally compiling a portion of the recalculation interface that includes the one or more affected dependencies, without compiling the entire recalculation user interface.
